(19) United States
(12) Patent Application Publication
(10) Pub. No.: US 2007/0171587 A1
(43) Pub. Date: Jul. 26, 2007

(54) ESD PROTECTION CIRCUIT WITH FEEDBACK TECHNIQUE

(76) Inventors: Chien-Ming Lee, Tai-Tung Hsien (TW); Ming-Dou Ker, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 11/307,168

(22) Filed: Jan. 26, 2006

(51) Int. Cl. H02H 9/00

(52) U.S. Cl. 361/56

(57) ABSTRACT

The present invention provides ESD protection circuits. The circuit includes: a resistor, a capacitance, a first transistor, an inverter set, and a second transistor. The resistor is connected between a first voltage and node N1. The capacitor is connected between node N1 and a second voltage. The first transistor has a first terminal coupled to the first voltage, a second terminal coupled to the second voltage, and a third terminal coupled to node N2. The inverter set has an input terminal coupled to node N1 and an output terminal coupled to node N2. The second transistor has a first terminal coupled to a first inverter of the inverter set, a second terminal coupled to the second voltage, and a third terminal coupled to an output terminal of a second inverter of the inverter set. The output terminals of the first and the second inverters correspond to opposite logic levels.

### BACKGROUND OF THE INVENTION

1. Field of the Invention

The present invention relates to an electrostatic discharge (ESD) protection circuit, and more particularly, to an ESD protection circuit with feedback technique.

2. Description of the Prior Art

An ESD protection circuit provides a low-impedance path for ESD current. FIG. 1 shows a classic MOSFET-based, RC-triggered ESD protection circuit. This circuit has been widely used since its effectiveness. Key design parameters for such a protection circuit include the layout area, the current drawn during power-up, the quiescent VDD to VSS leakage current, and the immunity to mistriggering during operation conditions. Additionally, the trigger time of the protection circuit is a critical parameter. The MOSFET-based, RC triggered ESD protection circuit 100 shown in FIG. 1 comprises a resistor 110, a capacitor 120, an inverter chain 130, and a MOSFET 140. The resistor 110 is connected in series with the capacitor 120 between VDD and VSS. The resistor 110, the capacitor 120, and the inverter chain 130 form a detecting circuit to detect the occurrence of an ESD. The MOSFET 140 is utilized to provide a low-impedance path for the discharge current. The MOSFET 140 must be fully on for the duration of the ESD event. In this case, the RC timer of both the resistor 110 and the capacitor 120 is required to have a time constant greater than or equal to a pulse width of an ESD model (e.g., a human body model (HBM)). In practice, this requires the usage of a large area capacitor. This is wasted area from an ESD point-of-view because the protection level is solely determined by the size of the MOSFET 140. For advanced technologies with very thin gate oxide, the large MOS capacitor in the RC timer is associated with significant stand-by power consumption because of the large gate leakage current. Due to these problems, modified ESD protection circuits with a small capacitor are highly desirable.

The large RC time constant of the classic RC-triggered ESD protection circuit may cause the ESD to mistrigger during a fast power-up (rise time<10 μs). Therefore, the requirement for an improved ESD protection circuit is not only reduction of the capacitor size, but also a simultaneous reduction of the RC time constant.

An ESD protection circuit with a feedback MOSFET has been proposed as a mean to reduce the capacitance needed in the RC timer without compromising the ESD protection level. Please refer to FIG. 2. FIG. 2 is an ESD protection circuit with feedback MOSFET's. The ESD protection circuit 200 comprises a resistor 210, a capacitor 220, inverters 232, 234, 236, a MOSEFT 240, a feedback P-MOSFET 250, and a feedback N-MOSFET 260. The N-MOSFET 260 is utilized for holding the MOSFET 240 on. During ESD event, the N-MOSFET 260 will maintain the MOSFET 240 in the conducting state until the voltage on VDD drops below the threshold voltage of the MOSFET 240. The P-MOSFET 250 is utilized for reducing the current drawn during power-up. The P-MOSFET 250 helps to keep the gate voltage of the MOSFET 240 low during power-up. The ESD protection circuit 200 successfully reduces the capacitor size and addresses the mistriggering problem during a fast power-up. However, it does have some drawbacks. For sufficiently fast power-up, it can be still mistriggered. The circuit is particularly susceptible to mistriggering if a FET-based resistor rather than a polySi-based resistor is used in the RC timer. If a FET-based resistor is used, the RC time constant during power-up is larger than the designed-for value during ESD events. Of most concern, if mistriggering does occur, this ESD protection circuit 200 remains latched on until the power supply is recycled. Similarly, when the chip is operating, if the ESD protection circuit is triggered by an overshooting noise voltage on VDD, the ESD protection circuit 200 will remain on until the power supply is recycled.

### SUMMARY OF THE INVENTION

Therefore, it is an objective of the claimed invention to provide an ESD protection circuit.

According to an embodiment of the claimed invention, an ESD protection circuit is disclosed. The ESD protection circuit includes: a resistor device, a capacitance device, a first transistor, an inverter set, and a second transistor. The resistor device provides a specific resistance and has a first terminal coupled to a first voltage level and a second terminal coupled to a node N1. The capacitor device provides a specific capacitance and has a first terminal coupled to the node N1 and a second terminal coupled to a second voltage level. The first transistor has a first terminal coupled to the first voltage level, a second terminal coupled to the second voltage level, and a third terminal coupled to a node N2. The inverter set has an input terminal coupled to the node N1 and an output terminal coupled to the node N2. The inverter set comprises a plurality of serially-connected inverters, and each inverter has a P-MOSFET and an N-MOSFET. The second transistor has a first terminal coupled to a source of an N-MOSFET belonging to a first inverter of the inverter set, a second terminal coupled to the second voltage level, and a third terminal coupled to an output terminal of a second inverter of the inverter set. The output terminal of the first inverter and the output terminal of the second inverter correspond to opposite logic levels.

According to another embodiment of the claimed invention, an ESD protection circuit is disclosed. The ESD protection circuit includes: a resistor device, a capacitance device, a first transistor, a second transistor, a third transistor, and an inverter set. The resistor device provides a specific resistance and has a first terminal coupled to a first voltage level and a second terminal coupled to a node N1. The capacitor device provides a specific capacitance and has a first terminal coupled to the node N1 and a second terminal coupled to a second voltage level. The first transistor has a first terminal coupled to the first voltage level, a second terminal coupled to the second voltage level, and a third terminal coupled to a node N2. The second transistor has a first terminal coupled to the first voltage level, a second terminal coupled to a node N3, and a third terminal coupled to the node N1. The third transistor has a first terminal coupled to the node N3, a second terminal coupled to the second voltage level, and a third terminal coupled to a node N4. The inverter set has an input terminal coupled to the node N3 and an output terminal coupled to the node N2, and comprises a plurality of serially-connected inverters. The node N4 is coupled to an output terminal of a specific inverter of the inverter set, and the output terminal of the specific inverter and the node N3 correspond to opposite logic levels.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a prior art MOSFET-based, RC-triggered ESD protection circuit.

FIG. 2 is an ESD protection circuit with feedback MOSFET's.

FIG. 3 shows an ESD protection circuit according to a first embodiment of the present invention with N-MOSFET to discharge ESD current.

FIG. 4 shows an ESD protection circuit according to a second embodiment of the present invention with N-MOSFET to discharge ESD current.

FIG. 5 shows an ESD protection circuit according to a third embodiment of the present invention with P-MOSFET to discharge ESD current.

FIG. 6 shows an ESD protection circuit according to a forth embodiment of the present invention with P-MOSFET to discharge ESD current.

### DETAILED DESCRIPTION

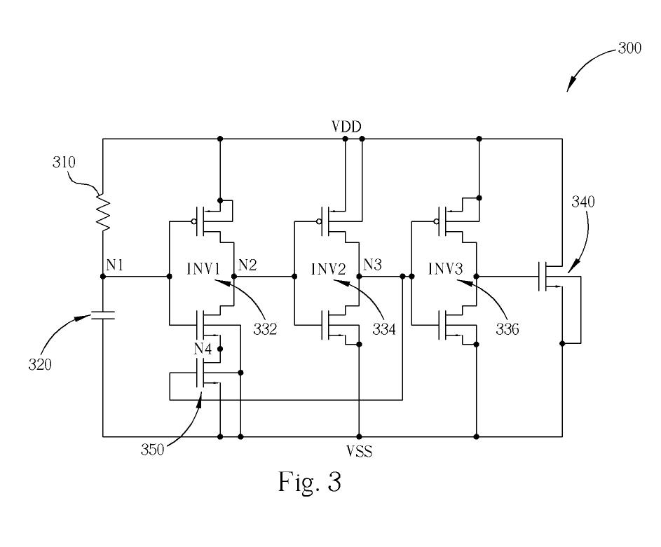

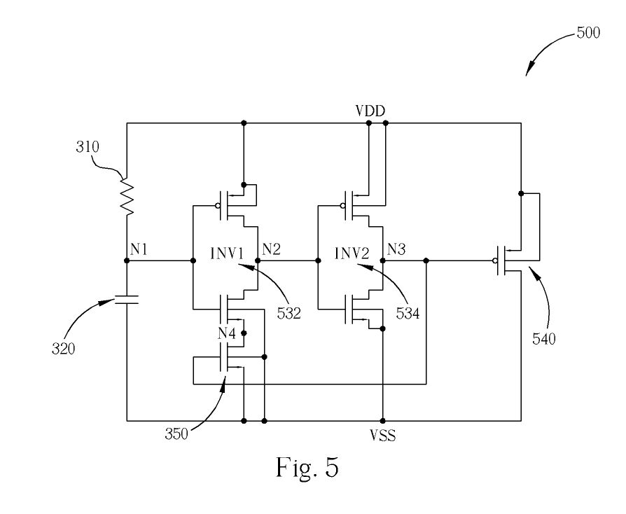

Please refer to FIG. 3. FIG. 3 shows an ESD protection circuit 300 according to a first embodiment of the present invention. The ESD protection circuit 300 comprises a resistor device 310, a capacitor device 320, an inverter set comprising inverters 332, 334, and 336, a MOSFET 340, and an N-MOSFET 350. The resistor device 310 is connected between the voltage level VDD and the node N1. The capacitance device 320 is connected between the node N1 and the voltage level VSS. The MOSFET 340 has a first terminal coupled to the voltage level VDD, a second terminal coupled to the voltage level VSS, and a third terminal. The inverter set formed by the three inverters 332, 334, and 336 has an input terminal coupled to the node N1, and an output terminal coupled to the third terminal of the MOSFET 340. Please note that the MOSFET 340 can be implemented by either an N-MOSFET or a P-MOSFET. If the MOSFET 340 is an N-MOSFET, the inverter set must comprise an odd number of inverters, as shown in FIG. 3. However, FIG. 3 servers as an example to describe the present invention, but it is not meant to be a limitation of the present invention. If the MOSFET 340 is an N-MOSFET, the first terminal of the MOSFET 340 is the drain, the second terminal is the source, and the third terminal is the gate. On the other hand, please refer to FIG. 5. FIG. 5 shows an ESD protection circuit with the same configuration of FIG. 3; however, the MOSFET 340 is implemented by a P-MOSFET. The inverter set must comprise an even number of inverters. Here, two inverters 532 and 534 show an exemplary example, and the first terminal of the MOSFET 540 is the source, the second terminal is the drain, and the third terminal is the gate. Please refer back to FIG. 3. The cascaded N-MOSFET 350 is connected to form the feedback circuit. The drain of the N-MOSFET 350 is couple through a node N4 to the source of the N-MOSFET of the inverter 332, the source of the N-MOSFET 350 is coupled to the voltage level VSS, and the gate of the N-MOSFET 350 is coupled to an output terminal of the inverter 334. Please note that the N-MOSFET to which the N-MOSFET 350 is coupled to belongs to the inverter 332, and the output voltage of the inverter 332 and the output voltage of the inverter 334 correspond to opposite logic levels, i.e., if the output voltage of the inverter 332 corresponds to a logic level “1”, then the output voltage of the inverter 334 corresponds to a logic level “0”, and vice versa. More specifically, in one embodiment, the inverter 332 is coupled directly to the inverter 334, as shown in FIG. 3; however, in other embodiments, the inverter 332 is coupled to the inverter 334 through an even number of inverters. Because the function of the ESD protection circuit 500 is similar to the ESD protection circuit 300, the description thereof is omitted for brevity.

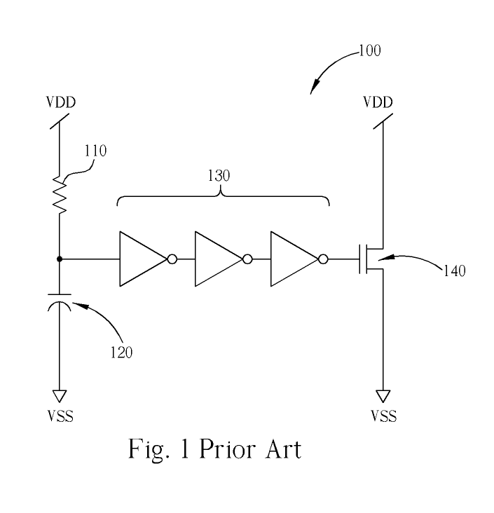

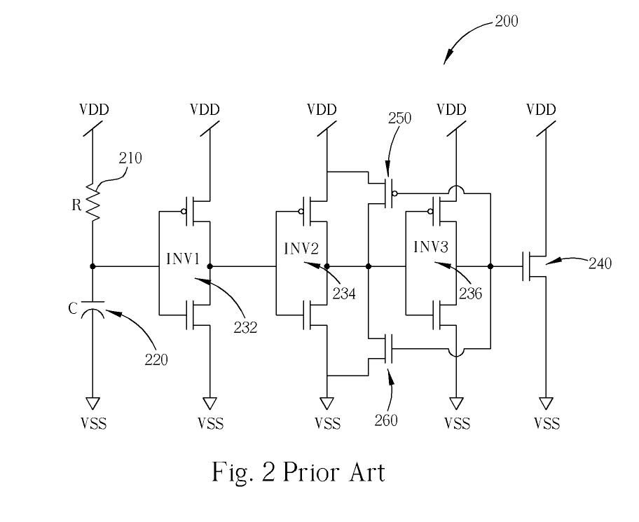

As in previous ESD protection circuits, which contain feedback, this ESD protection circuit 300 utilizes a small capacitor in the RC timer, relative to the classic ESD protection circuit 100 shown in FIG. 1. The primary difference between the ESD protection circuit 200 shown in FIG. 2 and the ESD protection circuit 300 shown in FIG. 3 is that the direct N-MOSFET 260 of the ESD protection circuit 200 tries to pull down the output voltage of the inverter 234, whereas the N-MOSFET 350 of the ESD protection circuit 300 prevents the output voltage of the inverter 332 from being pulled down. A kept-high voltage at the output terminal of the inverter 332 causes the gate voltage of MOSFET 340 to remain high. That is, a static feedback circuit has been converted into a dynamic feedback circuit. One of the immediate advantages is that FET-size ratio is not critical for this dynamic circuit. In the ESD protection circuit 300, the N-MOSFET 350 should not be so small as to affect the switching speed of inverter 332 and subsequently inverter 334.

The following is a detailed description of the ESD protection circuit 300. Since the function of the ESD protection circuit 500 has similar concept, the description thereof is omitted for brevity. Upon initiation of a positive ESD event between VDD and VSS, the voltage at gate of the MOSFET 340 is elevated due to capacitive coupling and the MOSFET 340 starts to conduct. The voltage at node N1 stays low for a time period set by the RC constant. This low voltage at the input of inverter 332 causes node N2 to be charged toward VDD, which in turn helps maintain node N3 at VSS. The N-MOSFET 350 has no effect at this time because the N-MOSFET of inverter 332 is off. The logic low signal at node N3 causes the gate voltage of the MOSFET 340 to be pulled all the way up to VDD, fully turning on the MOSFET 340. Thus, the MOSFET 340 is fully conducting within 3 inverter delays after the stress is initiated. Once the voltage at node N1 rises above the switching threshold of the inverter 332, the N-MOSFET of the inverter 332 is turned on and the P-MOSFET of the inverter 332 is turned off. However, since the voltage at node N3 is equal to VSS, the N-MOSFET 350 is turned off and the voltage at node N2 remains in the high state. The voltage at node N2 goes down just a little due to charge sharing between node N2 and the node N4. While the voltage difference between node N2 and VDD is less than the threshold voltage of the P-MOSFET of the inverter 334, the voltage of the node N3 and in turn the gate voltage of the MOSFET 340 will not be perturbed and the MOSFET 340 stays on well beyond the time constant of the RC filter. The voltage drop due to charge sharing is really small; this favorable result arises because the capacitance at node N2 is significantly larger than the capacitance at node N4 because the inverter 334 is sized larger than the inverter 332 for minimization of switching time.

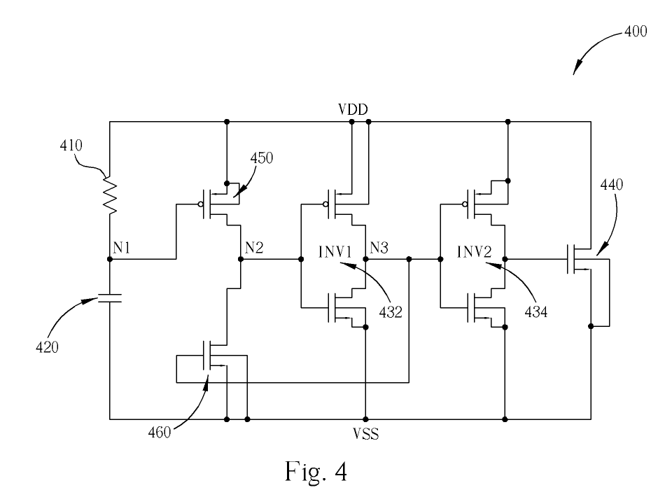

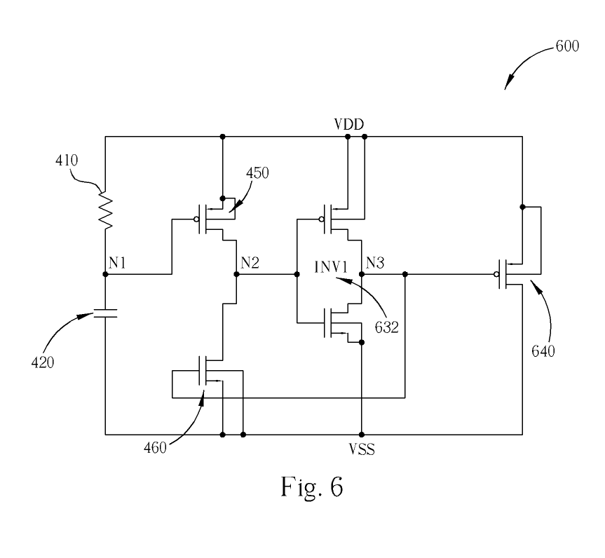

Please refer to FIG. 4. FIG. 4 shows an ESD protection circuit 400 according to a second embodiment of the present invention. The ESD protection circuit 400 comprises a resistor device 410, a capacitor device 420, an inverter set comprising inverters 432 and 434, a MOSFET 440, a P-MOSFET 450, and an N-MOSFET 460. The resistor device 410 is connected between the voltage level VDD and the node N1. The capacitance device 420 is connected between the node N1 and the voltage level VSS. The MOSFET 440 has a first terminal coupled to the voltage level VDD, a second terminal coupled to the voltage level VSS, and a third terminal. The inverter set formed by the inverters 432 and 434 has an input terminal coupled to a node N2, and an output terminal coupled to the third terminal of the MOSFET 440. The P-MOSFET 450 has a source coupled to the voltage level VDD, a drain coupled to the node N2, and a gate coupled to the node N1. The N-MOSFET 460 has a source coupled to the voltage level VSS, a drain coupled to the node N2, and a gate coupled to the node N3, which is the output terminal of the inverter 432. The voltage at the node N2 and the voltage at the node N3 correspond to opposite logic levels, i.e., if the voltage at the node N2 corresponds to a logic level “1”, then the voltage at the node N3 corresponds to a logic level “0”, and vice versa. More specifically, in one embodiment, the node N2 and the node N3 are respectively the input terminal and the output terminal of the inverter 432, as shown in FIG. 4; however, in other embodiments, between the node N2 and the node N3 there could be an odd number of inverters. Please note that the MOSFET 440 can be implemented by either an N-MOSFET or a P-MOSFET. If the MOSFET 440 is an N-MOSFET, the inverter set must comprise an even number of inverters, as shown in FIG. 4. However, FIG. 4 servers as an example to describe the present invention, but it is not meant to be a limitation of the present invention. If the MOSFET 440 is an N-MOSFET, the first terminal of the MOSFET 440 is the drain, the second terminal is the source, and the third terminal is the gate. On the other hand, please refer to FIG. 6. FIG. 6 shows an ESD protection circuit with the same configuration of FIG. 4; however, the MOSFET 440 is implemented by a P-MOSFET. The inverter set must comprise an odd number of inverters. Here, an inverter 632 shows an exemplary example, and the first terminal of the P-MOSFET 640 is the source, the second terminal is the drain, and the third terminal is the gate. Please now refer back to FIG. 4. In some embodiments, there could also be another inverter set connected between the node N1 and the gate of the P-MOSFET 450. In this case, if the MOSFET 440 is an N-MOSFET as illustrated in FIG. 4, the two inverter sets must contain an even sum total of inverters; however, if the MOSFET 440 is a P-MOSFET as illustrated in FIG. 6, the two inverter sets must contain an odd sum total of inverters.

The N-MOSFET 460 is connected to form the feedback circuit. The primary difference between the ESD protection circuit 300 shown in FIG. 3 and the ESD protection circuit 400 shown in FIG. 4 is that the ESD protection circuit 300 utilizes the inverter 332 and the feedback N-MOSFET 350 to prevent the output voltage of the inverter 332 from being pulled down, whereas the ESD protection circuit 400 utilizes the P-MOSFET 450, and the N-MOSFET 460 to determine the voltage at node N2. A kept-high voltage at the output terminal of the node N2 causes the gate voltage of MOSFET 440 to remain high. That is, ESD protection circuit 400 is also a dynamic feedback circuit.

The following is a detailed description of the ESD protection circuit 400. Since the function of the ESD protection circuit 600 has similar concept, the description thereof is omitted for brevity. Upon initiation of a positive ESD event between VDD and VSS, the voltage at gate of the MOSFET 440 is elevated due to capacitive coupling and the MOSFET 440 starts to conduct. The voltage at node N1 stays low for a time period set by the RC constant. This low voltage at the node N1 causes the P-MOSFET 450 to turn on and therefore the voltage at node N2 is charged toward VDD, which in turn helps maintain node N3 at VSS. The logic low signal at node N3 causes the gate voltage of the MOSFET 440 to be pulled all the way up to VDD, fully turning on the MOSFET 440. Thus, the MOSFET 440 is fully conducting within 2 inverter delays after the stress is initiated. Once the voltage at node N1 rises such that the voltage difference between the voltage at node N1 and VDD is less than the threshold of the P-MOSFET 450, the P-MOSFET 450 is therefore turned off. However, since the voltage at node N3 is equal to VSS, the N-MOSFET 460 is turned off and the voltage at node N2 remains in the high state. The voltage at node N2 goes down gradually due to a small leakage current of the N-MOSFET 460. As long as the voltage at node N2 is larger than the threshold voltage of the inverter 432, the voltage of the node N3 and in turn the gate voltage of the MOSFET 440 will not be perturbed and the MOSFET 440 stays on well beyond the time constant of the RC filter.

In summary, by utilizing feedback techniques as illustrated in FIG. 3 through FIG. 6, an improved ESD protection circuit can be implemented with a reduced capacitance needed in the RC timer without compromising the ESD protection level. Moreover, these improved ESD protection circuits can also reduce the possibility of mistriggering during fast power-up.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electrostatic discharge (ESD) protection circuit, comprising:
a resistor device, providing a specific resistance and having a first terminal coupled to a first voltage level and a second terminal coupled to a node N1;
a capacitor device, providing a specific capacitance and having a first terminal coupled to the node N1 and a second terminal coupled to a second voltage level;
a first transistor, having a first terminal coupled to the first voltage level, a second terminal coupled to the second voltage level, and a third terminal coupled to a node N2;
an inverter set, having an input terminal coupled to the node N1 and an output terminal coupled to the node N2, wherein the inverter set comprises a plurality of serially-connected inverters each of which has a P-MOSFET and an N-MOSFET; and
a second transistor, having a first terminal coupled to a source of an N-MOSFET belonging to a first inverter of the inverter set, a second terminal coupled to the second voltage level, and a third terminal coupled to an output terminal of a second inverter of the inverter set, wherein an output terminal of the first inverter and the output terminal of the second inverter correspond to opposite logic levels.

2. The circuit of claim 1, wherein the first transistor is an N-MOSFET, and the first terminal of the N-MOSFET is the drain, the second terminal of the N-MOSFET is the source, and the third terminal of the N-MOSFET is the gate.

3. The circuit of claim 2, wherein the inverter set comprises an odd number of inverters.

4. The circuit of claim 1, wherein the first transistor is a P-MOSFET, and the first terminal of the P-MOSFET is the source, the second terminal of the P-MOSFET is the drain, and the third terminal of the P-MOSFET is the gate.

5. The circuit of claim 4, wherein the inverter set comprises an even number of inverters.

6. The circuit of claim 1, wherein the second transistor is an N-MOSFET, and the first terminal of the N-MOSFET is the drain, the second terminal of the N-MOSFET is the source, and the third terminal of the N-MOSFET is the gate.

7. An electrostatic discharge (ESD) protection circuit, comprising:
a resistor device, providing a specific resistance and having a first terminal coupled to a first voltage level and a second terminal coupled to a node N1;
a capacitor device, providing a specific capacitance and having a first terminal coupled to the node N1 and a second terminal coupled to a second voltage level;
a first transistor, having a first terminal coupled to the first voltage level, a second terminal coupled to the second voltage level, and a third terminal coupled to a node N2;
a second transistor, having a first terminal coupled to the first voltage level, a second terminal coupled to a node N3, and a third terminal coupled to the node N1;
a third transistor, having a first terminal coupled to the node N3, a second terminal coupled to the second voltage level, and a third terminal coupled to a node N4; and
a first inverter set, having an input terminal coupled to the node N3 and an output terminal coupled to the node N2, the first inverter set comprising a plurality of serially-connected inverters;
wherein the node N4 is coupled to an output terminal of a specific inverter of the first inverter set, and the output terminal of the specific inverter and the node N3 correspond to opposite logic levels.

8. The circuit of claim 7, further comprising:
a second inverter set, having an input terminal coupled to the node N1 and an output terminal coupled to the third terminal of the second transistor, wherein the second inverter set comprises a plurality of serially-connected inverters.

9. The circuit of claim 8, wherein the first transistor is an N-MOSFET, and the first terminal of the N-MOSFET is the drain, the second terminal of the N-MOSFET is the source, and the third terminal of the N-MOSFET is the gate.

10. The circuit of claim 9, wherein the first inverter set and the second inverter set comprise an even number of inverters.

11. The circuit of claim 8, wherein the first transistor is a P-MOSFET, and the first terminal of the P-MOSFET is the source, the second terminal of the P-MOSFET is the drain, and the third terminal of the P-MOSFET is the gate.

12. The circuit of claim 11, wherein the first inverter set and the second inverter set comprise an odd number of inverters.

13. The circuit of claim 8, wherein the second transistor is a P-MOSFET, and the first terminal of the P-MOSFET is the source, the second terminal of the P-MOSFET is the drain, and the third terminal of the N-MOSFET is the gate.

14. The circuit of claim 8, wherein the third transistor is an N-MOSFET, and the first terminal of the N-MOSFET is the drain, the second terminal of the N-MOSFET is the source, and the third terminal of the N-MOSFET is the gate.

15. The circuit of claim 7, wherein the first transistor is an N-MOSFET, and the first terminal of the N-MOSFET is the drain, the second terminal of the N-MOSFET is the source, and the third terminal of the N-MOSFET is the gate.

16. The circuit of claim 15, wherein the first inverter set comprises an even number of inverters.

17. The circuit of claim 7, wherein the first transistor is a P-MOSFET, and the first terminal of the P-MOSFET is the source, the second terminal of the P-MOSFET is the drain, and the third terminal of the P-MOSFET is the gate.

18. The circuit of claim 17, wherein the first inverter set comprises an odd number of inverters.

19. The circuit of claim 7, wherein the second transistor is a P-MOSFET, and the first terminal of the P-MOSFET is the source, the second terminal of the P-MOSFET is the drain, and the third terminal of the N-MOSFET is the gate.

20. The circuit of claim 7, wherein the third transistor is an N-MOSFET, and the first terminal of the N-MOSFET is the drain, the second terminal of the N-MOSFET is the source, and the third terminal of the N-MOSFET is the gate.
